(19) United States
(12) Patent Application Publication
(10) Pub. No.: US 2017/0372464 A1
(43) Pub. Date: Dec. 28, 2017

(54) PATTERN INSPECTION METHOD AND PATTERN INSPECTION APPARATUS

(71) Applicant: NGR Inc., Yokohama (JP)

(72) Inventor: Tadashi KITAMURA, Yokohama (JP)

(21) Appl. No.: 15/195,145

(22) Filed: Jun. 28, 2016

(51) Int. Cl. G06T 7/00; G06K 9/46; G06K 9/62

(52) U.S. Cl. CPC G06T 7/001; G06K 9/6206; G06K 9/4604; G06T 2207/30148; G06K 2209/19

(57) ABSTRACT

A method of inspecting patterns to-be-inspected having regular intervals, the same widths and heights by using an image of the patterns to-be-inspected is disclosed. The method includes the steps of: obtaining centroids, widths and heights of the patterns to-be-inspected from an image of the patterns to-be-inspected; obtaining regular intervals, a mean of widths and a mean of heights of the patterns to-be-inspected, as information of design data, from the centroids, the widths and the heights; and inspecting the patterns to-be-inspected by using the information of the design data and edges of the image of the patterns to-be-inspected.

### FIELD

The present invention relates to a pattern inspection method and a pattern inspection apparatus, and more particularly to a method and an apparatus of inspecting a fine pattern, such as a semiconductor integrated circuit (LSI) and a photomask (reticle) for the semiconductor, which are fabricated based on design data.

### BACKGROUND

The die-to-database comparison inspection method is used for inspecting patterns to-be-inspected of a semiconductor integrated circuit on a wafer. This method is a method of inspecting a pattern to-be-inspected by comparing an edge of a design data and an edge of an image of patterns to-be-inspected. The technology concerned is disclosed, for example, in U.S. Pat. No. 6,868,175 “Pattern inspection apparatus, pattern inspection method, and recording medium”. The entire contents of U.S. Pat. No. 6,868,175 are hereby incorporated by reference.

In the case where there is no design data, in order to use the die-to-database comparison inspection method, information of design data is generated and patterns to-be-inspected are inspected. In the case of contact holes having identical regular intervals, the same width and height, these intervals and the width and height are obtained from design data or by measuring the contact holes in the image of the patterns to-be-inspected. Next, line segment information to express shapes, constituted by rectangles having the obtained width and height and arranged in the obtained intervals, is made and then used as design data.

In the same manner, in the case of line and space patterns, line width and space width are obtained from design data or by measuring the line and space patterns in the image of the patterns to-be-inspected. Next, line segment information to express shapes, constituted by rectangles having the obtained line width and space width, is made and then used as design data.

In the case where the contact holes in the image of the patterns to-be-inspected have identical regular intervals, the same width and height, the above method can be used. However, in the case where the intervals, the widths or the heights of contact holes change at a certain position in the image of the patterns to-be-inspected, or in the case where boundary of the arrangement of the contact holes exists in the image of the patterns to-be-inspected, when the above method is used, a defect that should not be detected is obtained. Similarly, in the case where the line widths or the space widths change at a certain position in the image of the patterns to-be-inspected, a defect that should not be detected is obtained.

FIG. 1 is a schematic diagram showing an example in the case where intervals of contact holes change at a certain position in an image of patterns to-be-inspected and a defect that should not be detected is obtained. Circles 101 shown by broken lines represent contact holes, having identical regular intervals, the same width and height, in the image of the patterns to-be-inspected. Circles 102 shown by solid lines represent contact holes, having identical regular intervals, the same width and height, in the image of the patterns to-be-inspected. The regular intervals of circles 101 differ from the regular intervals of circles 102. Rectangles 103 shown by dotted lines have the same width and height as those of the circles 101 and the circles 102 and the same regular intervals as those of the circles 102. The rectangles 103 are used as design data. Because the circles 101 shift from the rectangles 103, defects are obtained from places where the circles 101 and the rectangles 103 are not matched.

FIG. 2 is a schematic diagram showing an example in the case where line widths or space widths change at a certain position in the image of the patterns to-be-inspected, and a defect that should not be detected is obtained. Because line parts of line and space patterns are larger than an image of patterns to-be-inspected, the line parts of the line and space patterns in the image of the patterns to-be-inspected are clipped out by size of the image of the patterns to-be-inspected and form rectangles.

In the same manner, design data of the line parts of line and space patterns is clipped out by size of the image of the patterns to-be-inspected and forms rectangles.

A rectangle 201 shown by broken lines represents a line part of the line and space patterns in the image of the patterns to-be-inspected. Rectangles 202 shown by solid lines represent line parts of the line and space patterns, having the same line width and space width, in the image of the patterns to-be-inspected. The line width of rectangles 201 differ from the line width of rectangles 202. Rectangles 203 shown by dotted lines have the same line width and space width as those of the rectangles 202. The rectangles 203 constitute line segment information which is used as design data. Because the rectangles 201 shift from the rectangles 203, defects are obtained from places where the rectangles 201 and the rectangles 203 are not matched.

In order to solve this problem, in the case where the intervals, the widths or the heights of the contact holes change at a certain position in the image of the patterns to-be-inspected, or in the case where boundary of the arrangement of the contact holes exists in the image of the patterns to-be-inspected, information to express these feature is added. However, in the case of complex design data, because it needs time-consuming procedure, it is not practical. Similarly, in the case where the line widths or the space widths change at a certain position in the image of the patterns to-be-inspected, the same problem occurs.

An object of this invention is to enable to inspect the above-mentioned contact holes and line and space patterns by using only the image of the patterns to-be-inspected and information, which can be obtained easily. As the information, whether patterns to-be-inspected are contact-holes or line and space patterns is needed. If choices of interval, width or height of contact holes, or choices of line width or space width of line and space patterns can be used, more precise inspection can be performed, but the choices are not necessarily needed.

The conditions described later are imposed on an image of patterns to-be-inspected so that inspection with low false defect detection rate is performed. As conditions of an image of patterns to-be-inspected of the contact holes, it is imposed that insides of the contact holes are darker than outside of the contact holes. Contours of the contact holes can be obtained by using a binary image obtained from the image of patterns to-be-inspected. By using the conditions, the contact holes can be recognized without using a template image.

If the following requirements are satisfied, an image of patterns to-be-inspected satisfying the above-mentioned condition can be obtained:

(1) An electron microscope such as a CD-SEM (Critical Dimension Scanning Electron Microscope) is used as an imaging device.

(2) Diameters of the contact holes, which are patterns to-be-inspected, are less than dozens of a diameter of an electron beam spot of the electron microscope.

As conditions of an image of patterns to-be-inspected of the line and space patterns, it is imposed that line parts of the line and space patterns are brighter than space parts of that. Contours of the line parts can be obtained by using a binary image obtained from the image of patterns to-be-inspected. By using the conditions, the line parts can be recognized without using a template image.

In order to obtain an image of patterns to-be-inspected satisfying the above-mentioned condition, it is necessary to satisfy the following requirement (3), instead of the requirement (2):

(3) By adjusting an acceleration voltage of the electron microscope, an image of patterns to-be-inspected, whose line parts are brighter than space parts of that, is obtained.

When the acceleration voltage is set to be several hundreds of volts, an image, whose edge parts only are bright, is obtained; however, when the acceleration voltage is set to be higher than that, the difference in material creates a contrast, and an image having contrast between line parts and space parts is obtained.

### SUMMARY OF THE INVENTION

In an embodiment, there is provided a method of inspecting patterns to-be-inspected having regular intervals, the same widths and heights by using an image of the patterns to-be-inspected, comprising the steps of: obtaining centroids, widths and heights of the patterns to-be-inspected from an image of the patterns to-be-inspected; obtaining regular intervals, a mean of widths and a mean of heights of the patterns to-be-inspected, as information of design data, from the centroids, the widths and the heights; and inspecting the patterns to-be-inspected by using the information of the design data and edges of the image of the patterns to-be-inspected.

In an embodiment, the patterns to-be-inspected are at least one of a plurality of contact holes and a plurality of island patterns.

In an embodiment, a binary image is used when the centroids, the widths and the heights are obtained.

In an embodiment, the regular intervals are obtained using positions obtained by projecting the centroid onto arrangement direction of the patterns to-be-inspected.

In an embodiment, inspecting of the patterns to-be-inspected uses at least one of:

(i) positions of centroids, widths and heights of rectangles of the design data, and positions of centroids, widths and heights of the patterns to-be-inspected;

(ii) perimeters of inellipses of rectangles of the design data, and perimeters of contours of the patterns to-be-inspected;

(iii) perimeters of incircles of rectangles of the design data, and perimeters of the contours of the patterns to-be-inspected;

(iv) the following items of inellipses of the rectangles of the design data:
(a) an area,
(b) a major radius and a minor radius, and
(c) direction of major axe
   and those of ellipses obtained from the contours of the patterns to-be-inspected by using the least squares method;

(v) radii or areas of incircles of the rectangles of the design data, and radii or areas of circles obtained from the contours of the contact holes by using the least squares method,

(vi) the radii or the areas of the incircles of the rectangles of the design data, and radii or areas of maximum empty circles of the contours of the patterns to-be-inspected; and

(vii) the widths and the heights of the rectangles of the design data; and lengths of longer sides and shorter sides of arbitrarily oriented minimum bounding rectangles of the contours of the patterns to-be-inspected.

In an embodiment, an inspection area is divided into regions, each of the regions having identical regular intervals, the same width and height exist, and the patterns to-be-inspected are inspected for each of the regions.

In an embodiment, the information of design data is obtained from a reference image instead of the image of the patterns to-be-inspected.

In an embodiment, statistics value of inspection results, which are obtained by using the image of the patterns to-be-inspected and by using the information of the design data obtained from the reference images, is used as inspection result.

In an embodiment, statistics values of the information of the design data obtained from a plurality of reference images are used as the information of the design data.

In an embodiment, there is provided a method of inspecting line and space patterns to-be-inspected having the same line widths and space widths by using an image of the patterns to-be-inspected, comprising the steps of: recognizing line parts and space parts in an image of the patterns to-be-inspected; obtaining means of line widths of the line parts as line widths of design data; obtaining means of space widths of the space parts as space widths of design data; and inspecting the patterns to-be-inspected by using information of the design data and edges of the image of the patterns to-be-inspected.

In an embodiment, the line parts and the space parts are recognized by using one of:

(i) one-dimensional data obtained by adding up pixel values of the image of the patterns to-be-inspected having the same coordinate of arrangement direction of the patterns to-be-inspected; and

(ii) one-dimensional data obtained by adding up edge information having the same coordinate of arrangement direction of the patterns to-be-inspected, the edge information being detected from the image of the patterns to-be-inspected.

In an embodiment, inspecting of the patterns to-be-inspected uses at least one of:

(i) detection of a short circuit and a broken circuit;

(ii) detection of a line width exceeding an allowable deformation quantity;

(iii) detection of a space width exceeding an allowable deformation quantity;

(iv) detection of a line edge roughness; and

(v) detection of a line width roughness.

In an embodiment, an inspection area is divided into regions, each of the regions having the same line width and space width, and the patterns to-be-inspected are inspected for each of the regions.

In an embodiment, the information of design data is obtained from a reference image instead of the image of the patterns to-be-inspected.

In an embodiment, statistics value of inspection results, which are obtained by using the image of the patterns to-be-inspected and by using the information of the design data obtained from the reference images, is used as inspection result.

In an embodiment, statistics values of the information of the design data obtained from a plurality of reference images are used as the information of the design data.

In an embodiment, there is provided an apparatus for inspecting patterns to-be-inspected having regular intervals, the same widths and heights by using an image of the patterns to-be-inspected, comprising: an image generation device configured to generate an image of the patterns to-be-inspected; and a main controller configured to obtain centroids, widths and heights of the patterns to-be-inspected from the image of the patterns to-be-inspected, obtain regular intervals, a mean of widths and a mean of heights of the patterns to-be-inspected, as information of design data, from the centroids, the widths and the heights, and inspect the patterns to-be-inspected by using the information of the design data and edges of the image of the patterns to-be-inspected.

In an embodiment, there is provided an apparatus for inspecting line and space patterns to-be-inspected having the same line widths and space widths by using an image of the patterns to-be-inspected, comprising: an image generation device configured to generate an image of the patterns to-be-inspected; and a main controller configured to recognize line parts and space parts in the image of the patterns to-be-inspected, obtain means of line widths of the line parts as line widths of design data, obtain means of space widths of the space parts as space widths of design data, and inspect the patterns to-be-inspected by using information of the design data and edges of the image of the patterns to-be-inspected.

According to the above-described embodiments, the inspection result, which is equivalent to inspection result of the die-to-database comparison inspection method, can be obtained from an image of patterns to-be-inspected without using design data or template image. Examples of the patterns to-be-inspected include contact holes having the same width and the same height and arranged at regular intervals, and line-and-space patterns having the same line width and the same space width.

The above-described embodiments can specify a position at which the interval, the width, and the height of the contact holes change, and can also specify a position at which the line width and the space width of the line-and-space patterns change. Further, matching of design data and the image of the patterns to-be-inspected, which is performed in the die-to-database comparison, is replaced with method of estimating design data from the image of the patterns to-be-inspected. As a result of these, processing can be simplified, and false defect detection due to matching error can be reduced.

### BRIEF DESCRIPTION OF THE FIGURES

FIG. 1 is a is a schematic diagram showing an example in the case where intervals of contact holes change at a certain position in an image of patterns to-be-inspected and a defect that should not be detected is obtained;

FIG. 2 is a schematic diagram showing an example in the case where line widths or space widths change at a certain position in the image of the patterns to-be-inspected, and a defect that should not be detected is obtained;

FIG. 3 is a schematic diagram showing an embodiment of a pattern inspection apparatus;

FIG. 4 is a schematic diagram showing an embodiment of an image generation device of the pattern inspection apparatus;

FIG. 5 is a schematic diagram showing a method of determining regular intervals, the same widths and heights of contact holes;

FIG. 6 is a schematic diagram showing an example of design data of contact holes;

FIG. 7 is a schematic diagram showing three regions, each of regions having identical regular intervals;

FIG. 8 is a schematic diagram showing a method of determining a line width and a space width of line and space patterns;

FIG. 9 is a schematic diagram showing an example of line and space patterns including a short-circuit and a broken circuit;

FIG. 10 is a schematic diagram showing an example of design data corresponding to line patterns having the same line width and space width;

FIG. 11 is a schematic diagram showing a method of recognizing line parts by detecting edges of the image of the patterns to-be-inspected and by obtaining one-dimensional data by adding information of the edges;

FIG. 12 is a schematic diagram showing a method of inspection using an image of patterns to-be-inspected and reference images; and

FIG. 13 is a schematic diagram showing another method of inspection using an image of patterns to-be-inspected and reference images.

### DETAILED DESCRIPTION OF THE EMBODIMENTS

Hereafter, referring to the drawings, embodiments of the present invention will be described in detail.

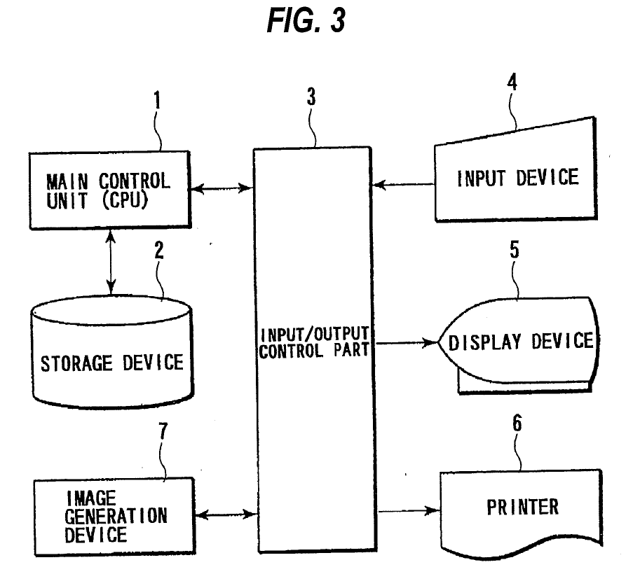

FIG. 3 is a schematic diagram showing an embodiment of a pattern inspection apparatus. The pattern inspection apparatus according to this embodiment comprises a main control unit 1, a storage device 2, an input/output control unit 3, an input device 4, a display device 5, a printer 6, and an image generation device 7.

The main control unit 1 comprises a CPU (Central Processing Unit), and manages and controls the whole apparatus. The main control unit 1 is coupled to the storage device 2. The storage device 2 may be in the form of a hard disk drive, a flexible disk drive, an optical disk drive, or the like. The input device 4 such as a keyboard and a mouse, the display device 5 such as a display for displaying input data, calculation results, and the like, and the printer 6 for printing the calculation results and the like are coupled to the main control unit 1 through the input/output control unit 3.

The main control unit 1 has an internal memory (internal storage device) for storing a control program such as an OS (Operating System), a program for the pattern inspection, necessary data, and the like. The main control unit 1 is configured to realize the pattern inspection with these programs. These programs can be initially stored in a flexible disk, an optical disk, or the like, read and stored in a memory, a hard disk, and the like before execution, and then executed.

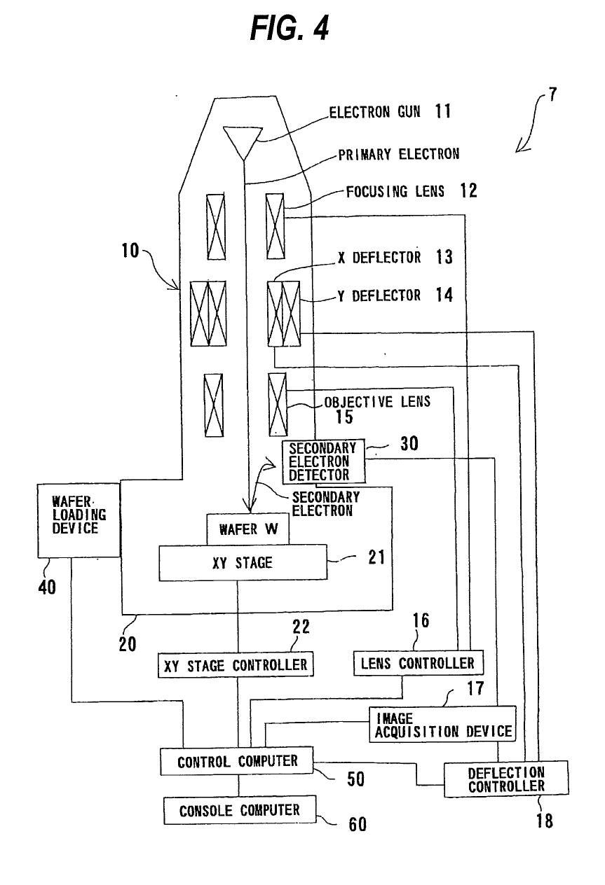

FIG. 4 is a schematic diagram of an embodiment of the image generation device 7 of the pattern inspection apparatus. As shown in FIG. 4, the image generation device 7 generally comprises an irradiation system 10, a specimen chamber 20, and a secondary electron detector 30. In this embodiment, the image generation device 7 comprises a scanning electron microscope.

The irradiation system 10 comprises an electron gun 11, a focusing lens 12 for focusing primary electrons emitted from the electron gun 11, an X deflector 13 and a Y deflector 14 for deflecting an electron beam (charged particle beam) in the X and Y directions, respectively, and an objective lens 15. The specimen chamber 20 has an XY stage 21 movable in the X and Y directions. A wafer W as a specimen can be loaded into and unloaded from the specimen chamber 20 by a wafer-loading device 40.

In the irradiation system 10, primary electrons emitted from the electron gun 11 are focused by the focusing lens 12, deflected by the X deflector 13 and the Y deflector 14, and focused and applied by the objective lens 15 to the surface of the wafer W.

When the primary electrons are applied to the wafer W, the wafer W emits secondary electrons, which are detected by the secondary electron detector 30. The focusing lens 12 and the objective lens 15 are coupled to a lens controller 16, which is coupled to a control computer 50. The secondary electron detector 30 is coupled to an image acquisition device 17, which is also coupled to the control computer 50. Intensity of the secondary electrons detected by the secondary electron detector 30 is converted into an image of a pattern to-be-inspected by the image acquisition device 17. A field of view is defined as the largest region where the primary electrons are applied and an image without distortion can be acquired.

The X deflector 13 and the Y deflector 14 are coupled to a deflection controller 18 that is also coupled to the control computer 50. The XY stage 21 is connected to an XY stage controller 22 that is also coupled to the control computer 50.

The wafer-loading device 40 is also coupled to the control computer 50. The control computer 50 is coupled to a console computer 60.

Next, embodiments of the inspection method of the present invention will be described in detail.

(Contact Holes)

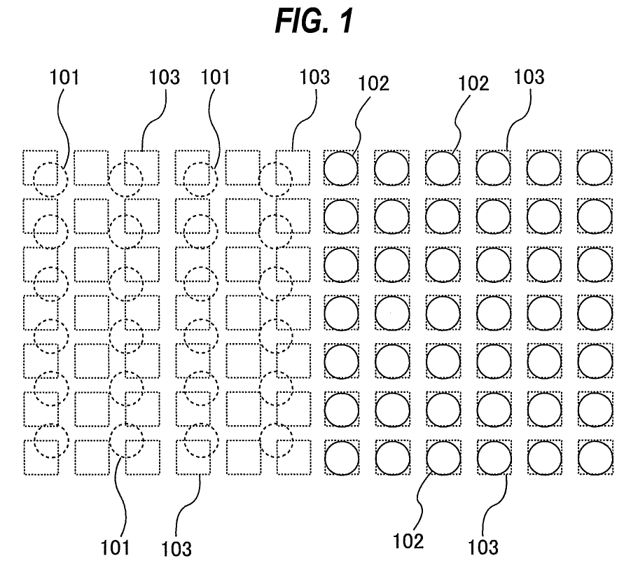

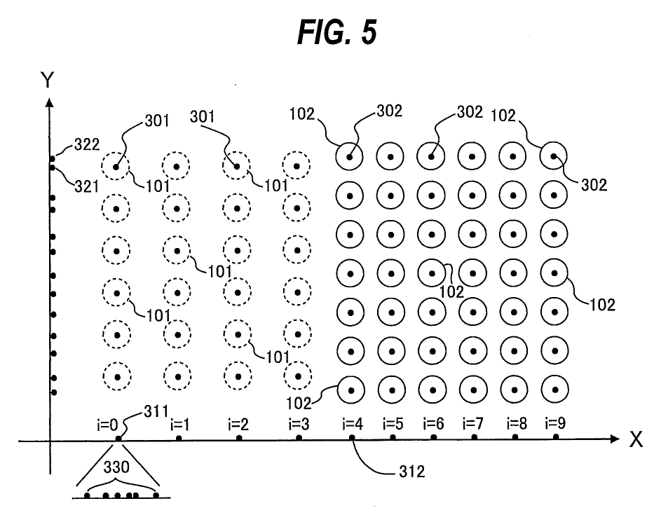

FIG. 5 is a schematic diagram showing a method of obtaining regular intervals, the same widths and heights of contact holes. Circles shown by broken lines and circles shown by solid lines are the same contact holes 101 and 102 in FIG. 1.

In this embodiment, the contact holes 101 and 102 are arranged in the X direction and Y direction at regular intervals.

Centroids 301 shown by dots are centroids of the contact holes 101.

### The Centroids are Obtained by the Following Procedure:

A binary image is obtained by binarizing the image of the patterns to-be-inspected; and contours are obtained by tracing the binary image. Freeman Chain Code can be used as a method of tracing the binary image. The obtained contours are polygons whose vertices are edges of the contact holes. The centroids 301 are obtained as centroids of the contour polygons. Alternatively, the centroids 301 may be obtained from pixels obtained by using Connected-component labeling. Widths and heights of the contact holes 101 are also determined from the contours that have been obtained for determining the centroids.

In the same manner, centroids 302, widths and heights of the contact holes 102, each depicted by a solid line, are obtained.

Positions 311 on the X-axis shown by dots are positions obtained by projecting a plurality of the centroids 301 onto the X-axis. Positions 312 on the X-axis are positions obtained by projecting a plurality of the centroids 302 onto the X-axis. In the same manner, positions 321 on the Y-axis are positions obtained by projecting a plurality of the centroids 301 onto the Y-axis. Positions 322 on the Y-axis are positions obtained by projecting a plurality of the centroids 302 onto the Y-axis. Positions 330 on the X-axis represent enlarged positions 311 on the X-axis. In the positions 330 on the X-axis, six positions 311 on the X-axis exist.

The intervals of the contact holes in the X direction is obtained by the following procedure:

Step 1: In the case where a line pattern, a defect, or the like may exist in the image of the contact holes patterns to-be-inspected, the following process is performed. Ranges of width and height of patterns that should be recognized as a contact hole are predetermined. If a width or a height of a pattern to-be-inspected, which have been obtained from a contour, exceeds the predetermined ranges, the pattern to-be-inspected is not recognized (or identified) as a contact hole. Instead of using the ranges of width and height, range of area may be used.

Step 2: A position on the X-axis is searched in the right direction from the leftmost of position 330 on the X-axis. If a distance between the obtained position and the leftmost of position 330 is less than a predetermined allowance δ, the obtained position is registered as a set of positions in the X-axis. The allowance δ is nearly equal to an allowable shift quantity of the centroids of the contact holes. In this embodiment, the positions 330 from the leftmost to the sixth are registered as the set of the positions on the X-axis. The positions on the X-axis after the seventh position are registered as a different set of the positions in the X-axis. In this case, the seventh position 330 is substituted for the first left of position 330.

A mean position of the positions in the set is determined. Let gₓ[i] be the obtained mean position. In this embodiment, an index i is an integer from 0 to 9. The first mean position gₓ[0] in the X-axis exists near the positions 311 in the X-axis. The mean position gₓ[4] in the X-axis exists near the positions 312 in the X-axis.

Step 3: In the same case as the above Step 1, the number of positions on the X-axis, which are used to determine the mean position, is limited. Generally, a plurality of defects do not exist in a range less than the allowance δ of the X coordinate. If the number of positions on the X-axis is one, the pattern to-be-inspected used to determine the mean position is not recognized (or identified) as a contact hole. The number may be two or more, in consideration of a safety factor.

Step 4: Intervals (gₓ[i+1]-gₓ[i]), i=0 to 8 are determined from the obtained mean position and the next mean position. Intervals, whose differences are less than the allowance δ, are registered as a set of intervals. In this embodiment, one of sets of intervals includes intervals (gₓ[1]-gₓ[0]), (gₓ[2]-gₓ[1]) and (gₓ[3]-gₓ[2]). Another set of intervals includes intervals (gₓ[5]-gₓ[4]), (gₓ[6]-gₓ[5]), (gₓ[7]-gₓ[6]), (gₓ[8]-gₓ[7]) and (gₓ[9]-gₓ[8]).

Step 5: A regular interval pₓ and a starting point sₓ of one set of the intervals are determined from mean positions gₓ by using the following equations:

$${p}_{x} = \frac{{g}_{x} [ {i}_{end} ] - {g}_{x} [ {i}_{start} ]}{{i}_{end} - {i}_{start}}$$

$${s}_{x} = \frac{{\sum }_{i = {i}_{start}}^{{i}_{end}} ( {g}_{x} [ i ] - ( i - {i}_{start} ) {p}_{x} )}{{i}_{end} - {i}_{start} + 1}$$

where iₛₜₐᵣₜ is an index which is used when the mean positions gₓ was obtained firstly; and i_{end} is an index which is used when the mean positions gₓ was obtained finally. The obtained regular interval pₓ and the starting point sₓ are used as design data. The regular interval pₓ is a mean of intervals in the set of the intervals.

For example, a regular interval pₓ and a starting point sₓ in the X direction are determined from mean positions from gₓ[0] to gₓ[3]. In this example, indices iₛₜₐᵣₜ=0 and i_{end}=3.

$${p}_{x} = \frac{{g}_{x} [ 3 ] - {g}_{x} [ 0 ]}{3 - 0}$$

$${s}_{x} = \frac{( {g}_{x} [ 0 ] - 0 {p}_{x} ) + ( {g}_{x} [ 1 ] - 1 {p}_{x} ) + ( {g}_{x} [ 2 ] - 2 {p}_{x} ) + ( {g}_{x} [ 3 ] - 3 {p}_{x} )}{3 - 0 + 1}$$

The starting point sₓ exists near the positions 311 on the X-axis.

Step 6: Next, a regular interval of the contact holes in the Y direction is obtained by performing the above-mentioned processes from Step 2 to Step 5. Here, the X-axis in the above-mentioned steps is exchanged into the Y-axis. In this embodiment, two different regular intervals in the Y direction exist. If the above-mentioned steps are performed naively, a regular interval cannot be obtained. To solve this problem, an inspection area is divided into regions, each region having identical regular intervals, the same width and height. Then the patterns to-be-inspected are inspected for each divided region by using the above-mentioned steps.

On the contrary, if a plurality of regular intervals in the X direction exist, a regular interval cannot be obtained like the above. To solve this problem, it is determined whether a regular interval in the X direction or a regular interval in the Y direction should be firstly obtained. The number of sets of intervals in the X direction and the number of sets of intervals in the Y direction are obtained. If the number of sets of intervals in the X direction is less than that in the Y direction, the sets of regular intervals in the X direction should be firstly obtained, otherwise those it the Y direction should be firstly obtained.

Step 7: Means of the widths and heights, which have been obtained for obtaining contours, are used as a width and a height of design data of the contact holes.

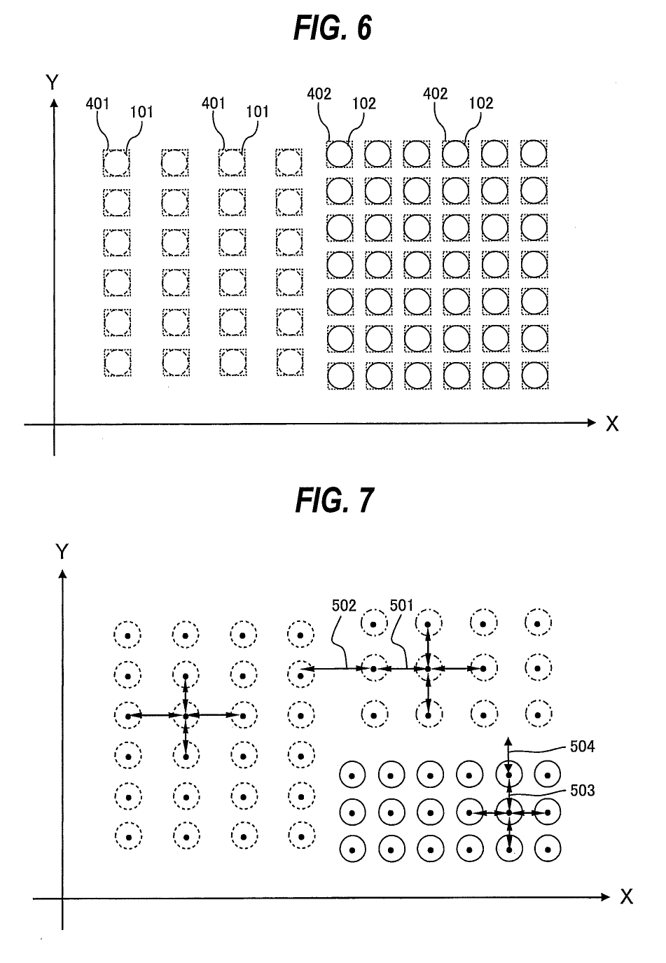

FIG. 6 is a schematic diagram showing an example of design data of contact holes. In FIG. 6, rectangles 401 and 402, which are design data, and rectangles 101 and 102, which are contact holes in the image of the patterns to-be-inspected, are shown.

Step 8: An inspection used in the die-to-database inspection method is performed by using the obtained design data and the contour obtained from edge information of the image of the patterns to-be-inspected. The following measurements are used for inspection:

(i) positions of centroids, widths and heights of the rectangles of the design data; and those of the contact holes,

(ii) perimeters of inellipses of rectangles of the design data; and perimeters of contours of the contact holes,

(iii) perimeters of incircles of rectangles of the design data; and perimeters of contours of the contact holes,

(iv) the following items of inellipses of the rectangles of the design data:
(a) an area,
(b) a major radius and a minor radius, and
(c) direction of major axe
   and those of ellipses obtained from the contours of the contact holes by using the least squares method,

(v) radii or areas of incircles of the rectangles of the design data; and that of circles obtained from the contours of the contact holes by using the least squares method,

(vi) the radii or the areas of the incircles of the rectangles of the design data; and that of maximum empty circles of the contours of the contact holes, and

(vii) the widths and the heights of the rectangles of the design data; and lengths of longer sides and shorter sides of arbitrarily oriented minimum bounding rectangles of the contours of the contact holes.

Step 9: The following processing is additionally performed on a width and a height of a rectangle of design data as needed:

(i) If distribution of the width or the height is not localized, the distribution is stratified and a mean of the width or the height is obtained for each stratum.
(ii) If it's known that design data are squares, lengths of sides of squares are used.
(iii) An amount obtained by another way is added to the obtained width or height to correct it.

Step 10: end

In the case where there are different regular intervals in the X direction and different intervals in the Y direction, an inspection area is divided into regions, each of the regions having identical regular intervals, and then regular intervals in the X direction and the Y direction are obtained for each region. The following two-dimensional processing is an expanded version of the above-mentioned one-dimensional processing. FIG. 7 is a schematic diagram showing three regions, each of the regions having identical regular intervals. In FIG. 7, contact holes, which are not illustrated in FIG. 5, are illustrated by chain lines. Each region having identical regular intervals is obtained by the following procedure:

(i) Intervals between each contact hole and an adjacent contact hole in the X direction and the Y direction are obtained. Contact holes may be shifted less than the allowance δ in the Y direction when obtaining a distance in the X-direction. In the same manner, intervals in the Y-direction are obtained.

(ii) If an absolute difference between an interval in negative direction of the X coordinate and an interval in positive direction is not less than the allowance δ, such a position is determined to be a boundary of a region of the contact holes having regular intervals. In the same manner, a boundary of a region in direction of the Y coordinate is determined.

Intervals shown by arrows 501 are intervals in the X direction of the contact holes shown by chain lines. There is a contact hole beneath the position of arrow 502 with a distance less than the allowance δ. However, a difference between an interval shown by the arrow 502 and the intervals shown by arrows 501 is not less than the allowance δ. Accordingly, a part where the arrow 502 exists is a boundary of a region where the contact holes have the same intervals.

Interval shown by arrows 503 is a regular interval in the Y direction of the contact holes shown by solid lines, while there is no adjacent contact hole in a direction shown by arrows 504, so that a part where the arrow 504 exists is a boundary of a region where the contact holes have regular intervals.

(iii) A region, where there are contact holes having the same intervals in the X direction and the Y direction, is determined. Each interval shown by an arrow except for the arrow 504 and 504 is a regular interval of the contact holes shown by one of a solid line, a dotted line, and a chain line.

In the case where contact holes are arranged in an inclined direction, the inclined direction is obtained using the autocorrelation method or the like, and then the obtained direction and a direction orthogonal to the obtained direction are used instead of the X direction and the Y direction used in the previous embodiment.

The following methods for improving accuracy of the contour information obtained from the contact hole can be used.

(1) A binary image is obtained by binarizing the image of the patterns to-be-inspected in the vicinity of the contact hole; and contours are obtained again for improving accuracy of the interval, the width and the height.

(2) By connecting edges detected from profiles by the edge detection used in the die-to-database comparison method, accuracy of the interval, the width and the height are improved. The edge has information of a starting point (with a sub pixel accuracy), a direction, and the amplitude for each pixel.

(3) If choices of the interval, the width and the height of the contact holes are previously known, the nearest choice to the obtained value is used.

In the case where there is no contact hole having regular intervals, the same width and height in the image of the patterns to-be-inspected, inspection is performed by using a method in another embodiment described later.

Although, the above inspection method uses the image of the patterns to-be-inspected in which the insides of the contact holes in are darker than outside, the inspection method can be also used in the case of island patterns whose insides are brighter than outside.

(Line and Space Patterns)

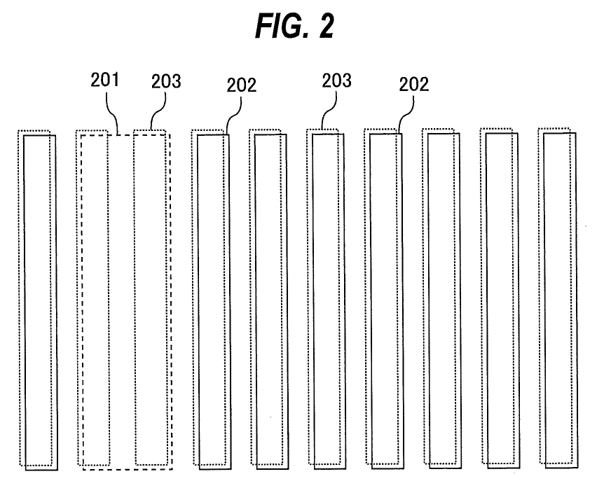

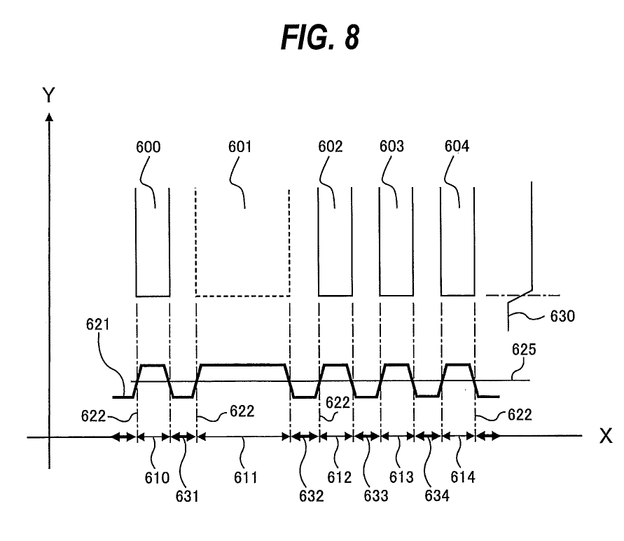

FIG. 8 is a schematic diagram showing a method of obtaining a line width and a space width of line and space patterns. A rectangle 601 shown by broken line represents an enlarged rectangle 201 shown by broken line in FIG. 2. A rectangle 602 shown by solid line represents an enlarged rectangle 202 shown by solid line in FIG. 2. Rectangles 600, 601, 602, 603 and 604 are line parts in an image of patterns to-be-inspected.

In this embodiment, the case where the line and space patterns in the Y direction are arranged in the X direction is described.

Arrows 610, 611, 612, 613 and 614 represent line widths of rectangles 600, 601, 602, 603 and 604, respectively. An allowance ε, which is substantially equal to an allowable deformation quantity of the line widths, is predetermined. Differences between the arrows 612, 613 and 614, which show the line widths, are less than the allowance ε, while a difference between the arrow 611 and the arrow 612 is not less than the allowance ε. A difference between the arrow 611 and the arrow 610 is also not less than the allowance ε.

Thick arrows 631, 632, 633 and 634 represent space widths of the line and space patterns. In this embodiment, to simplify description, the space widths are all the same.

If differences of line widths are less than the allowance ε and differences of space widths are less than the allowance ε, the line parts are judged as line and space pattern having the same line width and space width.

A polyline 621 represents one-dimensional data obtained by adding up pixel values of the image of the patterns to-be-inspected having the same X-coordinate value. Using the polyline 621, line parts and space parts are recognized according to the following procedure:

Step 1: A threshold for binarization is determined from the one-dimensional data corresponding to the polyline 621. Position 625 corresponds to the obtained threshold. Parts of the one-dimensional data which are larger than the threshold are line parts, otherwise those are space parts.

Step 2: Positions where the one-dimensional data are equal to the threshold are obtained. Chain lines 622 are vertical line segments extending through the obtained positions.

Step 3: Parts between the chain lines 622, where arrows 610, 611, 612, 613 and 614 representing line widths exist, are recognized as line parts.

Reasons why the polyline 621 is used are enumerated as follows.

(1) Even if two lines short-circuit partially, the short-circuited lines are recognizable as two line patterns. By the tracing of a binary image, those are recognized as one pattern.

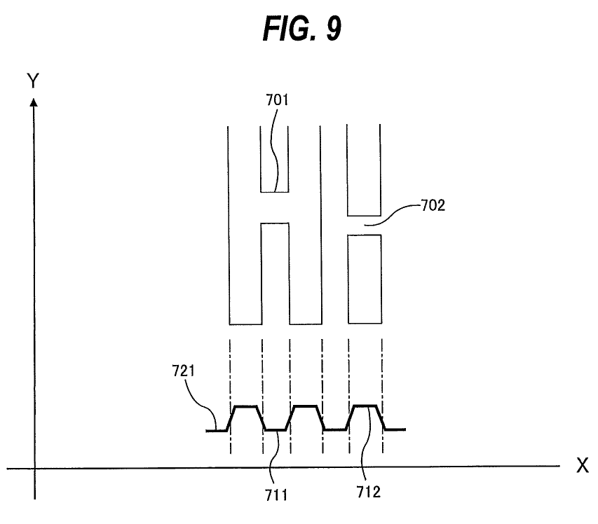

FIG. 9 is a schematic diagram showing an example of line and space patterns including a short circuit and a broken circuit. The short circuit is shown by a short circuit 701 and the broken circuit is shown by a broken circuit 702. A polyline 721 corresponds to the polyline 621 in FIG. 8. Because the short circuit 701 is considerably smaller than the line pattern, a part 711 of polyline 721 corresponding to a space part does not greatly vary with or without the short-circuit 701.

(2) In the same manner, even if a line is separated into two line patterns by breaking, these two line patterns are recognizable as a single line pattern. By the tracing of a binary image, those are recognized as two patterns.

The broken circuit 702 is considerably smaller than the line pattern, a part 712 of polyline 721 corresponding to a line part does not vary greatly with or without the broken circuit 702.

(3) Because the one-dimensional data is obtained by accumulation, the one-dimensional data is robust against noise.

A line width and a space width are obtained according to the following procedure:

Step 1: In order to obtain a starting position of the line patterns having the same line width and space width, it is examined whether difference between a line width of the leftmost line pattern 600 and a line width of the next line pattern 601 is less than the allowance ε. In this case, the difference between these line widths is not less than the allowance ε, so that the line patterns 600 and 601 are not judged as line patterns having the same line width and space width. In the same manner, the line patterns 601 and 602 are not judged as line patterns having the same line width and space width.

Step 2: It is examined whether difference between line widths of the line patterns 602 and 603 is less than the allowance ε. In this case, the difference between these line widths is less than the allowance ε, so that the line patterns 602 and 603 are judged as line patterns having the same line width and space width. The line patterns 602 and 603 are newly registered to a set of line patterns having the same line width and space width.

Step 3: It is examined whether difference between line widths of the line patterns 603 and 604 is less than the allowance ε; also it is examined whether difference between space widths is less than the allowance ε. In this case, the conditions with regard to both of line width and space width are satisfied, so that the line pattern 604 is registered to the set of the line patterns.

By repeating the above process, the set of line patterns is obtained. In the case where the conditions with regard to width or space is not satisfied, registration to the set of line patterns is terminated, then this procedure returns to the Step 1 to start registration to a new set of line patterns.

When the set of the line patterns has been obtained, a mean of line widths and a mean of space widths of the line patterns existing in the set are obtained as the line width of and the space width of design data, and inspection is performed using the mean of line widths and the mean of space widths.

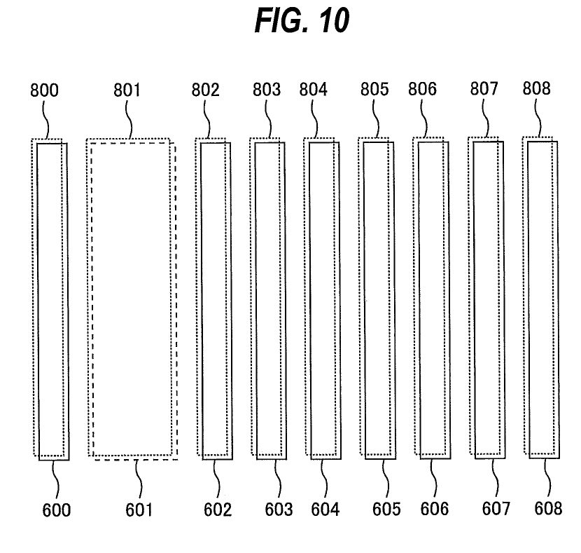

FIG. 10 is a schematic diagram showing an example of design data corresponding to line patterns having the same line width and space width. Rectangles 800 to 808 represent line patterns in the design data; and rectangles 600 to 608 represent line patterns in the image of the patterns to-be-inspected. The rectangles 600 to 604 are the same as the rectangles 600 to 604 in FIG. 8. Each of the rectangles 800 and 801 is a single line pattern; and the rectangles 802 to 808 are line patterns having the same line width and space width.

An inspection area is divided into the following regions, each of the regions having the same line width and space width:

(i) a region where the rectangle 800 exists,

(ii) a region where the rectangle 801 exists, and

(iii) a region where the rectangles 802 to 808 exist.

The information of the design data is obtained for each of the regions, and the patterns to-be-inspected are inspected for each of the regions.

Step 4: An inspection used in the die-to-database inspection method is performed by using the obtained design data and edge information obtained from the image of the patterns to-be-inspected. The following inspection can be performed:

(i) detection of short circuit and broken circuit

(ii) detection of a line width exceeding an allowable deformation quantity

(iii) detection of a space width exceeding an allowable deformation quantity

(iv) detection of a line edge roughness

(v) detection of a line width roughness

The following methods for improving accuracy of the contour information obtained from the line and space patterns can be used.

(1) By connecting edges detected from profiles by the edge detection used in the die-to-database comparison method, accuracy of the line width and space width of the line and space patterns are improved.

(2) If choices of the line width and space width of the line and space patterns are previously known, the nearest choice to the obtained value is used.

The above-discussed embodiment is directed to the case where the line and space patterns in the Y direction are arranged in the X direction. The same processing can be applied to the case where the line and space patterns are arranged in the Y direction, as well. If it is unknown whether the arrangement direction of the line pattern is X direction or Y direction, the arrangement direction is recognized by the following procedure:

(1) In the same manner as the polyline 621, a polyline 630 representing one-dimensional data obtained by adding up pixel values of the image of the patterns to-be-inspected having the same Y-coordinate is obtained.

(2) If variation of the polyline 621 is bigger than variation of the polyline 630, the arrangement direction of the line pattern is determined to be the X direction and otherwise the arrangement direction is determined to be the Y direction. In the case shown in FIG. 8, because the variation of the polyline 621 is larger than the variation of the polyline 630, the arrangement direction is determined to be the X direction. The variation can be determined using a standard deviation, a range, or the like.

In the case where the line and space patterns are arranged in an inclined direction, the inclined direction is obtained using the autocorrelation method or the like, and then the obtained direction and a direction orthogonal to the obtained direction are used instead of the X direction and the Y direction used in the previous embodiment.

In this embodiment, the one-dimensional data obtained by adding up the pixel values of the image of the patterns to-be-inspected is used. In one embodiment, one-dimensional data obtained by adding up information of the edges detected from the image of the patterns to-be-inspected may be used.

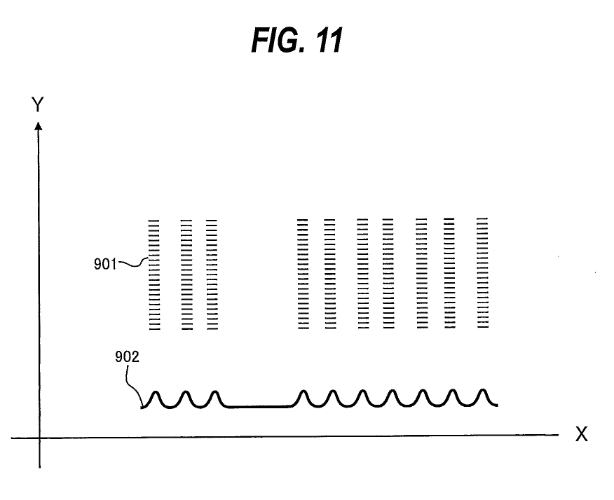

FIG. 11 is a schematic diagram showing a method of recognizing line parts by detecting edges of the image of the patterns to-be-inspected and by obtaining one-dimensional data by adding up information of the edges.

First-order spatial derivatives of the X and Y directions are obtained by the Sobel operator, and root mean square values of those are used as edge information. Edge information represents difference between pixel value and value of the neighboring pixel. Horizontal line parts 901 are places where the root mean square values are large. A polyline 902 shows one-dimensional data obtained by adding up the root mean square values having the same X-coordinate value. Maxima of polyline 902 are recognized as boundaries of line parts and space parts. Parts between the adjacent boundaries, in which pixel values are larger than an average pixel value, are line parts, otherwise are space parts.

In the case where there is no line and space pattern having the same line width and space width in the image of the patterns to-be-inspected, inspection is performed by using a method in another embodiment described later.

### Another Embodiment

In the case where the same shape patterns in two or more die on a wafer are inspected, die-to-die comparison method is used. This method is a method of recognizing a defect by comparing pixel value of an image of pattern to-be-inspected and pixel value of a reference image. The reference image is an image of the same shape pattern existing in a different position from position where the image of the patterns to-be-inspected is obtained.

In substitution for this method, information of design data may be obtained from a reference image and inspection may be performed using obtained information. Even if there is no contact hole having regular intervals, the same width and height in the image of the patterns to-be-inspected, or even if there is no line and space pattern having the same line width and space width in the image of the patterns to-be-inspected, inspection can be performed.

As the inspection method, one of the following two methods can be used:

(1) Inspection results are obtained by using the image of the patterns to-be-inspected and information of design data obtained from the reference images. A plurality of the inspection results are obtained, the obtained inspection results are processed to obtain statistics, and then the obtained statistics is used as inspection result. A mean, a median, a minimum value and a maximum value can be used as the statistics. When the median is used, the inspection result becomes robust against fliers. The more reference images are used, the more accurate inspection result becomes.

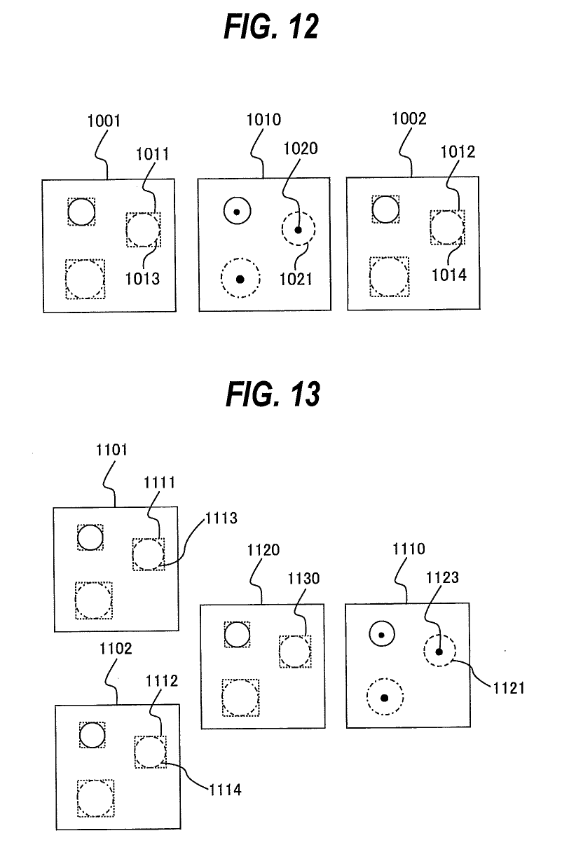

FIG. 12 is a schematic diagram showing a method of inspection using an image of patterns to-be-inspected and reference images. An example of obtaining shift amount of a centroid of contact holes is described using FIG. 12. A rectangle 1011 to express information of design data is created by obtaining a centroid, a width and a height of a contact hole 1013 in a reference image 1001. A centroid 1020 of a contact hole 1021 in an image of patterns to-be-inspected 1010 corresponding to the rectangle 1011 is determined. A shift amount S₁ is obtained by comparing the centroid of the contact hole 1013 and the centroid 1020 of the contact hole 1021. In the same manner, a shift amount S₂ is obtained by comparing the centroid of the contact hole 1014 in a reference image 1002 and the centroid 1020 of the contact hole 1021. A mean of the obtained shift amount S₁ and S₂ is a shift amount of the centroid 1020 of the contact hole 1021. In the case of more than two reference images, the shift amount is obtained in the same manner.

(2) Centroids, widths and heights of contact holes, which exist in the same position relative to die origins, are obtained from the reference images and statistics values of the obtained values are used as information of design data.

FIG. 13 is a schematic diagram showing another method of inspection using an image of patterns to-be-inspected and reference images. Another example of obtaining shift amount of a centroid of contact holes is described using FIG. 13. A rectangle 1111 to express information of design data is created by obtaining a centroid, a width and a height from a contact hole 1113 in a reference image 1101. In the same manner, a rectangle 1112 is created from a contact hole 1114 in a reference image 1102. A rectangle 1130 having mean position of positions of the centroids, a mean of the widths and a mean of the height is created. Other contact holes are also processed in the same manner, and a set of rectangles 1120 representing information of design data is obtained.

A centroid 1123 of a contact hole 1121 in an image of patterns to-be-inspected 1110 corresponding to the rectangle 1030 is determined. A shift amount is obtained by comparing a centroid of the rectangle 1130 and the centroid 1123 of the contact hole 1121

In the case of line and space patterns, instead of the centroid, the width and the height, a line width and a space width are used.

The pattern inspection apparatus can store therein the rectangles which represent the information of design data obtained from the reference image according to the above-described manner, and can inspect patterns having the same shape at the same location in different dies on a wafer, and can also inspect patterns having the same shape at the same location in different shots on a wafer.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A method of inspecting patterns to-be-inspected having regular intervals, the same widths and heights by using an image of the patterns to-be-inspected, comprising the steps of:
obtaining centroids, widths and heights of the patterns to-be-inspected from an image of the patterns to-be-inspected;
obtaining regular intervals, a mean of widths and a mean of heights of the patterns to-be-inspected, as information of design data, from the centroids, the widths and the heights; and
inspecting the patterns to-be-inspected by using the information of the design data and edges of the image of the patterns to-be-inspected.

2. The method of claim 1, wherein the patterns to-be-inspected are at least one of a plurality of contact holes and a plurality of island patterns.

3. The method of claim 1, wherein a binary image is used when the centroids, the widths and the heights are obtained.

4. The method of claim 1, wherein the regular intervals are obtained using positions obtained by projecting the centroid onto arrangement direction of the patterns to-be-inspected.

5. The method of claim 1, wherein inspecting of the patterns to-be-inspected uses at least one of:
(i) positions of centroids, widths and heights of rectangles of the design data, and positions of centroids, widths and heights of the patterns to-be-inspected;
(ii) perimeters of inellipses of rectangles of the design data, and perimeters of contours of the patterns to-be-inspected;
(iii) perimeters of incircles of rectangles of the design data, and perimeters of the contours of the patterns to-be-inspected;
(iv) the following items of inellipses of the rectangles of the design data:
(a) an area,
(b) a major radius and a minor radius, and
(c) direction of major axe
and those of ellipses obtained from the contours of the patterns to-be-inspected by using the least squares method;
(v) radii or areas of incircles of the rectangles of the design data, and radii or areas of circles obtained from the contours of the contact holes by using the least squares method,
(vi) the radii or the areas of the incircles of the rectangles of the design data, and radii or areas of maximum empty circles of the contours of the patterns to-be-inspected; and
(vii) the widths and the heights of the rectangles of the design data; and lengths of longer sides and shorter sides of arbitrarily oriented minimum bounding rectangles of the contours of the patterns to-be-inspected.

6. The method of claim 1, wherein an inspection area is divided into regions, each of the regions having identical regular intervals, the same width and height exist, and the patterns to-be-inspected are inspected for each of the regions.

7. The method of claim 1, wherein the information of design data is obtained from a reference image instead of the image of the patterns to-be-inspected.

8. The method of claim 7, wherein statistics value of inspection results, which are obtained by using the image of the patterns to-be-inspected and by using the information of the design data obtained from the reference images, is used as inspection result.

9. The method of claim 7, wherein statistics values of the information of the design data obtained from a plurality of reference images are used as the information of the design data.

10. A method of inspecting line and space patterns to-be-inspected having the same line widths and space widths by using an image of the patterns to-be-inspected, comprising the steps of:
recognizing line parts and space parts in an image of the patterns to-be-inspected;
obtaining means of line widths of the line parts as line widths of design data;
obtaining means of space widths of the space parts as space widths of design data; and
inspecting the patterns to-be-inspected by using information of the design data and edges of the image of the patterns to-be-inspected.

11. The method of claim 10, wherein the line parts and the space parts are recognized by using one of:
(i) one-dimensional data obtained by adding up pixel values of the image of the patterns to-be-inspected having the same coordinate of arrangement direction of the patterns to-be-inspected; and
(ii) one-dimensional data obtained by adding up edge information having the same coordinate of arrangement direction of the patterns to-be-inspected, the edge information being detected from the image of the patterns to-be-inspected.

12. The method of claim 10, wherein inspecting of the patterns to-be-inspected uses at least one of:
(i) detection of a short circuit and a broken circuit;
(ii) detection of a line width exceeding an allowable deformation quantity;
(iii) detection of a space width exceeding an allowable deformation quantity;
(iv) detection of a line edge roughness; and
(v) detection of a line width roughness.

13. The method of claim 10, wherein an inspection area is divided into regions, each of the regions having the same line width and space width, and the patterns to-be-inspected are inspected for each of the regions.

14. The method of claim 10, wherein the information of design data is obtained from a reference image instead of the image of the patterns to-be-inspected.

15. The method of claim 14, wherein statistics value of inspection results, which are obtained by using the image of the patterns to-be-inspected and by using the information of the design data obtained from the reference images, is used as inspection result.

16. The method of claim 14, wherein statistics values of the information of the design data obtained from a plurality of reference images are used as the information of the design data.

17. An apparatus for inspecting patterns to-be-inspected having regular intervals, the same widths and heights by using an image of the patterns to-be-inspected, comprising:
an image generation device configured to generate an image of the patterns to-be-inspected; and
a main controller configured to
obtain centroids, widths and heights of the patterns to-be-inspected from the image of the patterns to-be-inspected,
obtain regular intervals, a mean of widths and a mean of heights of the patterns to-be-inspected, as information of design data, from the centroids, the widths and the heights, and
inspect the patterns to-be-inspected by using the information of the design data and edges of the image of the patterns to-be-inspected.

18. An apparatus for inspecting line and space patterns to-be-inspected having the same line widths and space widths by using an image of the patterns to-be-inspected, comprising:
an image generation device configured to generate an image of the patterns to-be-inspected; and
a main controller configured to
recognize line parts and space parts in the image of the patterns to-be-inspected,
obtain means of line widths of the line parts as line widths of design data,
obtain means of space widths of the space parts as space widths of design data, and
inspect the patterns to-be-inspected by using information of the design data and edges of the image of the patterns to-be-inspected.
